(19) United States
(12) Patent Application Publication
(10) Pub. No.: US 2024/0406639 A1
(43) Pub. Date: Dec. 5, 2024

(54) SPEAKER

(71) Applicant: SUNG JU SOUND CORP., Pocheon-si, Gyeonggi-do (KR)

(72) Inventor: Jong-Dae WON, Hwaseong-si, Gyeonggi-do (KR)

(73) Assignee: SUNG JU SOUND CORP., Pocheon-si, Gyeonggi-do (KR)

(21) Appl. No.: 18/700,262

(22) PCT Filed: Nov. 29, 2022
(86) PCT No.: PCT/KR2022/019046

§ 371 Date: Apr. 10, 2024

(30) Foreign Application Priority Data
Dec. 10, 2021 (KR) 10-2021-0176645
Mar. 3, 2022 (KR) 10-2022-0027481

(51) Int. Cl. H04R 9/06; H04R 7/12; H04R 7/18; H04R 9/02; H04R 9/04

(52) U.S. Cl. CPC H04R 9/06; H04R 7/12; H04R 7/18; H04R 9/025; H04R 9/045; H04R 2400/11

(57) ABSTRACT

The present invention provides a slim speaker comprising: a frame part forming the outer shape of the speaker; a magnetic field formation part connected to the frame part and forming a magnetic field; a voice coil part linked to the magnetic field formation part so as to vibrate according to an electrical signal; a terminal part electrically connected to the voice coil part and having a portion thereof exposed on the frame part; and a diaphragm connected to the voice coil part, wherein the voice coil part is connected to the diaphragm through a first part of the terminal part, and the terminal part comprises a second part and a bent part, the second part being farther away from the diaphragm than the first part, and the bent part being bent between the first part and the second part.

This application is a national phase of International Application No. PCT/KR2022/019046 filed Nov. 29, 2022, which claims priority to Republic of Korea (KR) Application No. 10-2022-0027481 filed Mar. 3, 2022, and Republic of Korea (KR) Application No. 10-2021-0176645 filed Dec. 10, 2021, each of which is incorporated herein by reference in its entirety.

### TECHNICAL FIELD

The present disclosure relates to a speaker including a bent metal bumper and suspension.

### BACKGROUND ART

In general, a speaker refers to an acoustic device emitting sound by converting the movement of a voice coil, when current flows through the voice coil in a magnetic field using a built-in magnet, into vibrations of a diaphragm to generate small waves in the air, by using an electrical signal input from an electrical signal source such as an amplifier, or the like. In other words, a speaker is a device creating sound by vibrating a diaphragm with an electrical signal.

Recently, as a device such as a display provided with a speaker has become slimmer, a speaker, a component used thereinside, is also required to be ultra-small and slim.

Conventionally, in order to miniaturize a speaker, a speaker provided with an integrated frame has been suggested in Korean Patent Application No. 10-2012-0106520, having a structure manufactured to enable slimming of a frame (speaker) while securing a space for the vibration of the damper (suspension).

Meanwhile, Patent Document 1 discloses that a voice coil portion is connected and a suspension formed of metal is formed integrally with the frame. However, when a width of the speaker is narrowed, interference between the metal suspension and the diaphragm may occur in the structure such as that in Patent Document 1, or to prevent the interference, a thickness of the suspension may become thin, which may cause a problem with durability or sound reproduction.
(Patent Document 1) KR10-1410393 B1

### SUMMARY OF INVENTION

### Technical Problem

An aspect of the present disclosure is to provide a speaker which has a narrow width, enables securing durability of a suspension and terminal portions, and is advantageous for sound reproduction.

### Solution to Problem

According to an aspect of the present disclosure, a speaker is provided.

According to an aspect of the present disclosure, a speaker generating sound according to an electrical signal is provided, the slim speaker including: a frame portion forming an exterior of the speaker; a magnetic field formation portion connected to the frame portion and forming a magnetic field; a voice coil portion linked to the magnetic field formation portion so as to vibrate according to an electrical signal; a diaphragm connected to the voice coil portion; and a terminal portion having a portion thereof exposed to the frame portion and electrically connected to the voice coil portion, wherein the voice coil portion is connected to the diaphragm through a first portion of the terminal portion, and the terminal portion includes a second portion and a bent portion, the second portion being farther away from the diaphragm than the first portion, and the bent portion being bent between the first portion and the second portion.

In an embodiment, the speaker further includes a suspension located between the frame portion and the diaphragm, enabling vibration of the diaphragm relative to the frame portion, and surrounding at least the bent portion and the second portion of the terminal portion.

The suspension and the frame portion may be formed integrally, and the terminal portion may be formed by insert injection into the suspension and the frame portion.

### Advantageous Effects of Invention

As set forth above, in the present disclosure, through a speaker having the above-described structure, the durability of the terminal portion and suspension may be secured even when a width of the speaker is narrow, and sufficient sound reproduction may be performed by securing a length of the suspension.

### BRIEF DESCRIPTION OF DRAWINGS

FIG. 1 is a perspective view and cross-sectional perspective view of a slim speaker.

FIG. 2 is a perspective view of a slim speaker according to an embodiment of the present disclosure.

FIG. 3 is an exploded perspective view of the slim speaker of FIG. 2.

FIG. 4 is an exploded perspective view of the frame of FIG. 3.

FIG. 5 is a cross-sectional perspective view and an enlarged view of portion A of the slim speaker of FIG. 2.

FIG. 6 is a bottom perspective view of the frame of the slim speaker of FIG. 2.

FIG. 7 is a bottom perspective view of a slim speaker according to another embodiment of the present disclosure.

### MODE FOR INVENTION

Hereinafter, preferred embodiments of the present disclosure will be described in detail so that those skilled in the art could easily practice the present disclosure with reference to the accompanying drawings. However, in describing a preferred embodiment of the present disclosure in detail, if it is determined that a detailed description of a related known function or configuration may unnecessarily obscure the subject matter of the present disclosure, the detailed description will be omitted. In addition, the same reference numerals are used throughout the drawings for portions having similar functions and actions. In addition, in the present specification, terms such as ‘upper,’ ‘upper portion,’ ‘upper surface,’ ‘lower,’ ‘lower portion,’ ‘lower surface,’ ‘side surface,’ and the like are based on the drawings, and in practice, it may be different depending on a direction in which the components are disposed.

In addition, throughout the specification, when apart is said to be ‘connected’ to another portion, this is not only when it is ‘directly connected,’ but also when it is ‘indirectly connected’ with other components therebetween. In addition, ‘including’ a certain component means that other components may be further included without excluding other components unless otherwise stated.

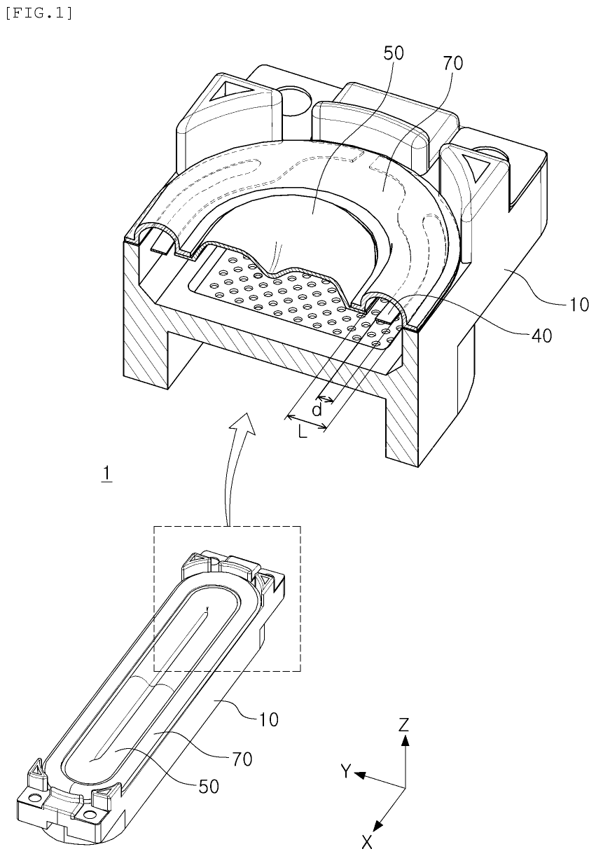

FIG. 1 illustrates a perspective view and a cross-sectional perspective view of a slim speaker.

In the present disclosure, a slim speaker 1 refers to a speaker in which a frame 10 has a rectangular shape having a long side and a short side when a diaphragm 50 is viewed from the front. In other words, the slim speaker means a speaker 1 including a frame 10 having a structure in which one side is shorter than the other side.

As shown in FIG. 1, in the case of the slim speaker 1, the length of one side of the frame 10 is shorter than the length of the other side. Therefore, when an edge portion 70 surrounding the diaphragm 50 with the same width L, and connecting the diaphragm 50 and the frame 10 is formed, a length thereof corresponding to the short side of the diaphragm 50 is even shorter.

In addition, in this slim speaker 1, the terminal portion 40 connected to a voice coil (not shown) connected to the diaphragm 50 should be connected to the voice coil without touching the diaphragm 50, the terminal portion 40 extends along the edge portion 70 into the width L of the edge portion 70. In this case, in order to secure the durability of the terminal portion 40, a width d of the terminal portion 40 should be sufficiently secured. In this case, the width L of the edge portion 70 should be increased due to the terminal portion 40, and the length of the short side of the diaphragm 50 becomes shorter, so that it is more difficult to produce sound of sufficient sound quality.

The present disclosure is to provide a slim speaker 1 that can secure a sufficient area of the diaphragm 50 in the slim speaker to which the diaphragm 50 and the voice coil are connected through the terminal portion 40 and secure durability of the terminal portion 40 connected to the voice coil.

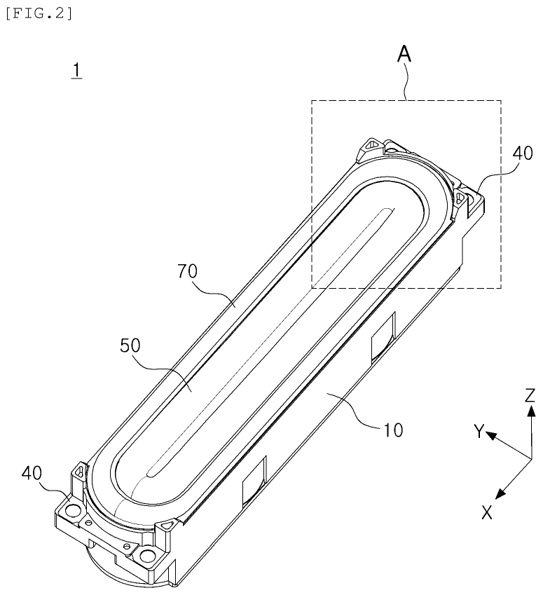

FIG. 2 illustrates a perspective view of a slim speaker 1 according to an embodiment of the present disclosure. As shown in FIG. 2, the slim speaker of FIG. 2 has no difference in appearance from the slim speaker 1 of FIG. 1, but the width of the short side of the diaphragm 50 is increased compared to FIG. 1, which may be not only advantageous for sound reproduction but also increase the durability of the terminal portion.

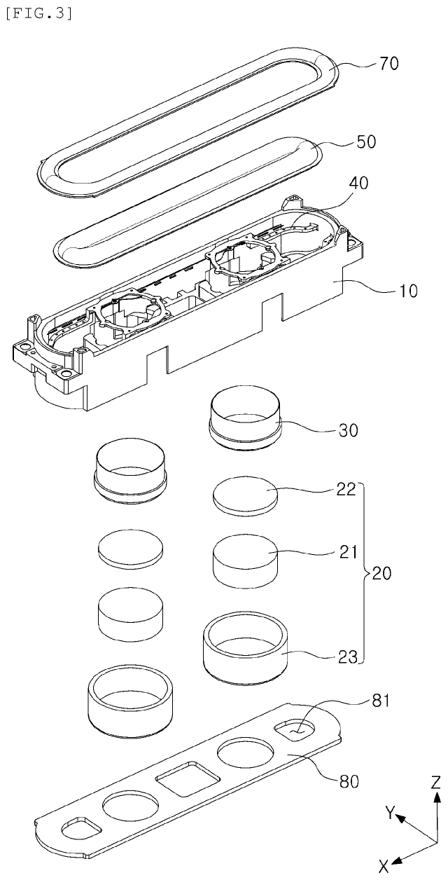

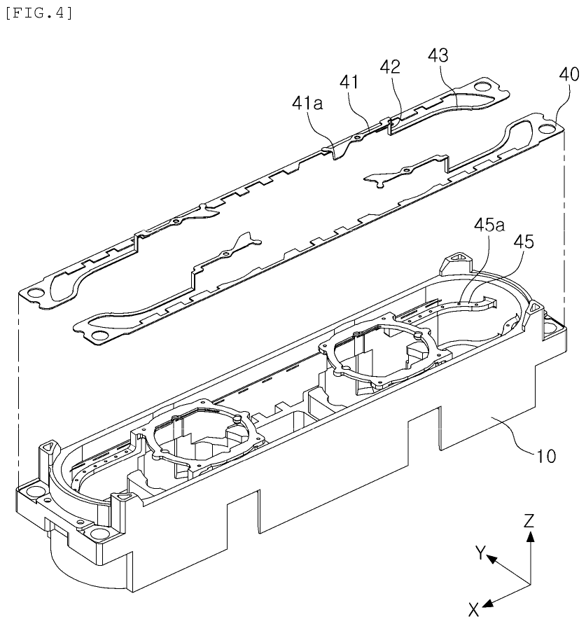

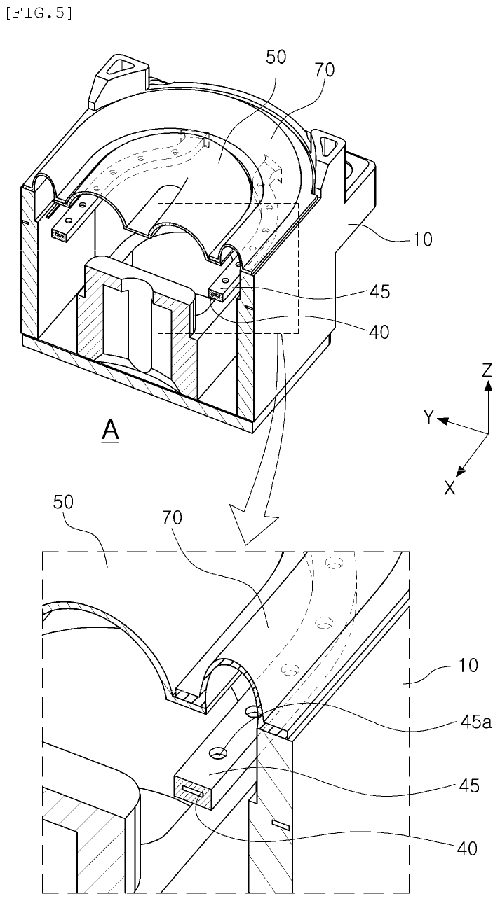

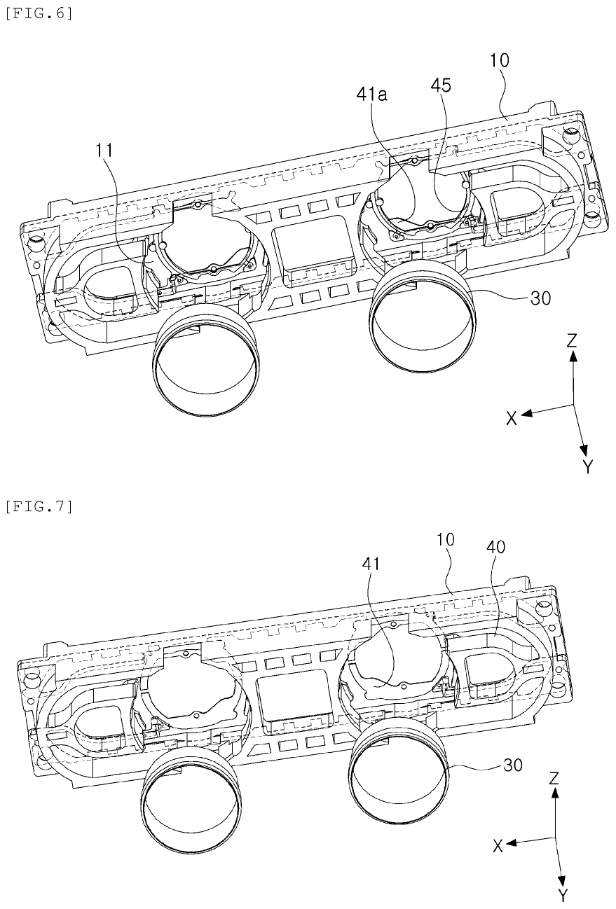

FIG. 3 illustrates an exploded perspective view of a slim speaker 1 according to an embodiment of the present disclosure, FIG. 4 illustrates an exploded perspective view of the frame 10 of FIG. 3, FIG. 5 illustrates a cross-sectional perspective view and an enlarged view of the slim speaker of FIG. 2, and FIG. 6 illustrates a bottom perspective view of the frame of the slim speaker of FIG. 2.

As shown in FIG. 3, the slim speaker 1 according to an embodiment of the present disclosure includes a frame portion 10 forming an exterior of a speaker 1; a magnetic field formation portion 20 disposed inside the frame portion 10 and forming a magnetic field; a voice coil portion 30 disposed adjacently to the magnetic field formation portion 20, and linked to the magnetic field formation portion 20 so as to vibrate according to an electrical signal; a terminal portion 40 having a portion thereof exposed to the frame portion 10 and electrically connected to the voice coil portion 30; a diaphragm 50 connected to the voice coil portion 30; a suspension 45 located between the frame portion 10 and the diaphragm 50, and enabling vibration of the diaphragm 50 relative to the frame portion 10; and a gasket 80 connected to the frame portion 10, and covering the frame portion 10 on the opposite side of the diaphragm 50.

As shown in FIG. 4, the frame portion 10 has a terminal portion 40 disposed therein and is formed integrally with the suspension 45. The terminal portion 40 is formed by insert injection into the frame portion 10 and the suspension 45, and a plurality of through-holes 45a are formed in the suspension 45.

The frame portion 10 forms an exterior of the slim speaker 1 having a length thereof in a second direction (X-direction) longer than a length thereof in a third direction (Y-direction), and includes a pair of magnet insertion portions 11 disposed to be spaced apart in the second direction (X-direction).

The magnetic field formation portion 20 includes a magnet 21 forming a magnetic field, a plate 22 disposed between the magnet 21 and the voice coil portion 30, and two sets of yokes 23 into which the magnet 21 is inserted, and each set thereof is inserted into a magnet insertion portion 11 of the frame portion 10 with the magnet 21 inserted into the yoke 23, respectively.

The voice coil portion 30 is connected to the terminal portion 40, and vibrates according to a signal transmitted through the terminal portion 40 exposed to the outside of the frame portion 10. The voice coil portion 30 is connected to the diaphragm 50 through the terminal portion 40, and the voice coil portion 30 vibrates together with the diaphragm 50 to reproduce sound. The voice coil portion 30 and the magnetic field formation portion 20 are disposed in a first direction (Z-direction).

A pair of terminal portions 40 are connected to the voice coil portion 30, the terminal portions 40 connected to the one voice coil portion 30 are symmetrical to each other, and as shown in FIG. 4, a pair of voice coil portions 30 are connected to the terminal portion 40.

The terminal portion 40 is configured to have one end thereof exposed to the outside of the frame portion 10 to receive an external signal, and the terminal portion 40 is formed by insert injection into the frame portion 10. In addition, the terminal portion 40 starts from the inside of the short side of the frame portion 10 when viewed from the first direction, extends with a bend, and is then connected to the voice coil portion 30. In general, the second portion 43 of the terminal portion 40 starts from a central portion of the frame portion 10 in the third direction from the inside of the frame portion 10, spreads, and then extends in the second direction, and is then connected to the bent portion 42. In this embodiment, the bent portion 42 extends in the first direction, and if the second portion 43 can be disposed to be farther away from the diaphragm 50 than the first portion 41, the bent portion 42 may also extend obliquely with respect to the first direction.

The terminal portion 40 is surrounded by a suspension 45 inside the frame portion 10, and therefore the rigidity and durability of the terminal portion 40 formed of metal are supplemented by the suspension 45 formed of a resin. However, the terminal portion 40 may function as a suspension without a suspension formed of a resin.

A section of the terminal portion 40 surrounded by the suspension 45 of a resin includes a first portion 41 connected to the voice coil portion 30 and the diaphragm 50, a bent portion 42 bent in an end of the first portion and extending in a first direction (Z-direction), and a second portion 43 connected to the bent portion 42 and extending with a bend on a plane perpendicular to the first direction and connected to the inside of the frame portion 10. The first portion 41 and the second portion 43 are located in different positions in the first direction (Z-direction), that is, the first portion 41 is located closer to the diaphragm 50 in the first direction, and the voice coil portion 30 and the diaphragm 50 are connected through the first portion 41.

In the present disclosure, the suspension 45 and the terminal portion 40 include a first portion 41, a bent portion 42, and a second portion 43, so that the overall length can be increased. Accordingly, an amplitude of vibrations of the voice coil portion 30 can be increased.

In addition, due to a second portion 43 located in a position different from that of the diaphragm 50 in the first direction, a width of the edge portion 70 may be determined independently of the width of the suspension 45 and the terminal portion 40. Accordingly, the proportion occupied by the edge portion 70 in a direction of the short side of the frame portion 10, that is, in the third direction, can be reduced, so that the width of the short side of the diaphragm 50 can be sufficient, which provides an advantageous effect in sound reproduction.

Meanwhile, as shown in FIG. 6, the suspension 45 surrounds a portion of the first portion 41 of the terminal portion 40. That is, the first portion 41 of the terminal portion 40 includes a connection portion 41a to be connected to the voice coil portion 30, and the first portion excluding the connection portion 41a may be surrounded by the suspension 45.

The suspension 45 includes a through-hole 45a formed in a portion surrounding the second portion 43, and the through-hole 45a may also be formed to surround the bent portion 42 and the first portion 41.

The diaphragm 50 is connected to the voice coil portion 30 through the first portion 41 of the terminal portion 40, and vibrates together with the voice coil portion 30 to generate sound. An exterior of the diaphragm 50 is surrounded by an edge portion 70, and the edge portion 70 is configured to connect the frame portion 10 and the diaphragm 50 and allow the diaphragm 50 to vibrate freely. In the case of the edge portion 70, as mentioned above, since the terminal portion 40 or the suspension 45 does not pass therethrough on the same plane, there is no room for interference, and it is sufficient to have a width for securing free movement of the diaphragm 50.

The gasket 80 is connected to the frame portion 10 on the opposite side of the diaphragm 50 and forms an internal space of the frame portion 10. A plurality of through-holes 81 are formed in the gasket 80 to facilitate sound transmission.

FIG. 7 illustrates another embodiment of the present disclosure.

In the case of the embodiment of FIG. 7, configurations other than the connection relationship between the terminal portion 40, the suspension 45, and the voice coil portion 30 are the same as those in the embodiments of FIGS. 2 to 6, so descriptions of configurations that do not differ will be omitted to avoid redundant description.

In FIG. 7, it is the same that the terminal portion 40 includes a first portion 41, a bent portion 42, and a second portion 43, but when the first portion 41 is viewed (Z-direction), a portion in the first direction corresponding to the voice coil portion 30 and the terminal portion 40 located inside the voice coil portion 30 are all exposed. In other words, the corresponding portions are not covered with resin and the metal material is exposed.

In this embodiment, since the first portion 41 is all exposed, when welding is performed to connect the first portion 41 and the voice coil portion 30, there is no concern that the suspension 45 of the resin is to be deformed. In particular, when welding is performed to connect the voice coil portion 30 and the first portion 41 when only a portion of the first portion 41 is exposed, as in the embodiment of FIGS. 2 to 6, there was a concern that the suspension 45 of the resin is deformed when an amount of heat input increased. However, as shown in FIG. 7, when the resin suspension 45 surrounds only the bent portion 42 and the second portion 43, there is no concern that the suspension 45 of the resin is deformed due to heat input, so manufacturing can be performed more easily.

While example embodiments have been illustrated and described above, it will be apparent to those skilled in the art that modifications and variations could be made without departing from the scope of the present disclosure as defined by the appended claims.

DESCRIPTION OF REFERENCE NUMERALS

| | |
|---|---|
| 1: SLIM SPEAKER | 10: FRAME PORTION |
| 20: MAGNETIC FIELD | |
| FORMATION PORTION | |
| 30: VOICE COIL PORTION | |
| 40: TERMINAL PORTION | 41: FIRST PORTION |
| 42: BENT PORTION | 43: SECOND PORTION |
| 45: SUSPENSION | |
| 50: DIAPHRAGM | 70: EDGE PORTION |
| 80: GASKET | 81: THROUGH HOLE |

1. A speaker, comprising:
a frame portion forming an exterior of a speaker;
a magnetic field formation portion disposed inside the frame portion and forming a magnetic field;
a voice coil portion disposed adjacently to the magnetic field formation portion, and linked to the magnetic field formation portion so as to vibrate according to an electrical signal;
a terminal portion having a portion thereof exposed to the frame portion and electrically connected to the voice coil portion; and
a diaphragm connected to the voice coil portion,
wherein the voice coil portion is connected to the diaphragm through a first portion of the terminal portion, and
wherein the terminal portion includes a second portion and a bent portion, the second portion being farther away from the diaphragm than the first portion, and the bent portion being bent between the first portion and the second portion.

2. The speaker of claim 1, wherein the voice coil portion and the magnetic field formation portion are disposed in a first direction, and
the diaphragm includes an edge portion connecting the frame and the diaphragm on the outside.

3. The speaker of claim 1, further comprising:
a suspension located between the frame portion and the diaphragm, enabling vibration of the diaphragm relative to the frame portion, and surrounding at least the bent portion and the second portion of the terminal portion,
wherein the frame portion and the suspension are formed integrally.

4. The speaker of claim 3, wherein the terminal portion is formed by insert injection into the frame portion and the suspension.

5. The speaker of claim 1, wherein the voice coil portion and the magnetic field formation portion are disposed in a first direction, and the first portion and the second portion are located in different positions in the first direction.

6. The speaker of claim 5, wherein the frame portion has a length in a second direction perpendicular to the first direction longer than a length in a third direction perpendicular to the first and second directions,
a portion of the second portion of the terminal portion extends in the second direction, and
the bent portion extends in the first direction.

7. The speaker of claim 6, wherein the plurality of voice coil portions and magnetic field formation portions are disposed to be spaced apart from the inside of the frame portion in the second direction.

8. The speaker of claim 7, wherein the slim speaker comprises a gasket connected to the frame portion, and covering the frame portion on the opposite side of the diaphragm.

9. The speaker of claim 8, wherein the gasket comprises a through-hole.

10. The speaker of claim 2, wherein the second portion extends with a bent when viewed from the first direction.

11. The speaker of claim 2, wherein in the first portion, when viewed from the first direction, a portion thereof corresponding to the voice coil portion and a terminal portion located inside the voice coil portion are all exposed.

12. The speaker of claim 2, wherein a portion of a terminal portion on the same plane as the first portion and located above the voice coil portion is surrounded by the suspension.

13. A speaker, comprising:
a frame portion forming an exterior of a speaker;
a magnetic field formation portion disposed inside the frame portion and forming a magnetic field;
a voice coil portion disposed adjacently to the magnetic field formation portion, and linked to the magnetic formation portion so as to vibrate according to an electric signal;
a terminal portion having a portion thereof exposed to the frame portion, and electrically connected to the voice coil portion;
a diaphragm connected to the voice coil portion; and
a suspension located between the frame portion and the diaphragm, and surrounding a portion of the terminal portion,
wherein the voice coil portion and the magnetic field formation portion are disposed in a first direction,
wherein the voice coil portion is connected to the diaphragm through a first portion of the terminal portion,
wherein the terminal portion includes a second portion and a bent portion, the second portion being farther away from the diaphragm than the first portion and the bent portion being bent between the first portion and the second portion, wherein the first portion and the second portion are located in different positions in the first direction.

14. The speaker of claim 13, wherein a distance between the second portion and the diaphragm is greater than a distance between the first portion and the diaphragm.

15. The speaker of claim 14, wherein the frame portion has a length in a second direction perpendicular to the first direction longer than a length in a third direction perpendicular to the first and second directions, and
a portion of the second portion of the terminal portion extends in the second direction.
